(19) United States
(12) Patent Application Publication
(10) Pub. No.: US 2018/0211349 A1
(43) Pub. Date: Jul. 26, 2018

(54) MOBILE DEVICE IDENTIFICATION SYSTEM AND METHOD

(71) Applicant: Lenovo (Singapore) Pte. Ltd., New Tech Park (SG)

(72) Inventors: Jonathan Gaither Knox, Morrisville, NC (US); Justin Tyler Dubs, Raleigh, NC (US); Russell Speight VanBlon, Raleigh, NC (US)

(21) Appl. No.: 15/415,059

(22) Filed: Jan. 25, 2017

(51) Int. Cl. G06Q 50/30; H04W 8/18; H04W 4/02; H04W 52/02; H04L 29/08; G01C 21/34

(52) U.S. Cl. CPC G06Q 50/30; H04W 8/183; G01C 21/34; H04W 52/0261; H04L 67/306; H04W 4/023

(57) ABSTRACT

A computer implemented method, device and computer program device are provided that under control of one or more processors configured with specific executable instructions. The methods obtains a user profile that includes a user device usage pattern associated with a user, receives a usage limit associated with a task and identifies a candidate mobile device from a pool of available mobile devices based on the usage limit and the user device usage pattern.

### FIELD

The present disclosure relates generally to mobile device sharing and more particularly to methods and systems to manage mobile device sharing.

### BACKGROUND OF THE INVENTION

Car sharing services are offered in numerous regions, cities, states and countries, to allow individuals to rent cars for short periods of time, often by the hour. Car sharing services are attractive to customers who may only occasionally use a vehicle as well as others who would like occasional access to a type of vehicle that differs from their day-to-day vehicle. Various commercial businesses offer and maintain car sharing services.

In addition, other types of services offer shared access to portable handheld devices, by holding the devices in a pool and allowing users to temporarily checked out the devices. For example, schools, universities, and libraries may offer pools of tablet devices or laptop computers that may be temporarily checked out.

However, car sharing services, and more generally mobile device sharing services, experience certain limitations. Car sharing services may offer different types of vehicles, such as electric vehicles and vehicles powered by fossil fuels. When a car is returned to a car sharing service site, the cars have various amounts of remaining fuel/charge as users do not always refill the tank or recharge the batteries. The next user is allowed to choose from all available vehicles to travel between start and destination locations or to perform a particular task. When individuals choose a vehicle, the individual is unaware of the fuel/charge level in the vehicle. Hence, the user is unaware of whether the chosen vehicle has sufficient fuel/charge to reach the destination location. Consequently, the user may need to refuel or recharge to the vehicle before starting a trip and/or at an intermediate point along a trip.

Similarly, when users check out mobile devices from a school or library, the user is not aware of the charge level of the device and the mobile device sharing service may not recharge the mobile device before offering the mobile device to the next user. Consequently, the user may check out a mobile device, only to find that the mobile device has insufficient battery storage left to complete a needed task.

A need remains for improved methods and systems that manage sharing services for mobile devices that allow users to choose devices that have sufficient energy to complete the user's intended purpose.

### SUMMARY

In accordance with embodiments herein a computer implemented method is provided comprising under control of one or more processors configured with specific executable instructions. The methods obtains a user profile that includes a user device usage pattern associated with a user, receives a usage limit associated with a task and identifies a candidate mobile device from a pool of available mobile devices based on the usage limit and the user device usage pattern. The user device usage pattern may indicate a driving style, an energy usage pattern and the like.

Optionally, the identifying may include identifying, as the candidate mobile device, one or more of the available mobile devices that has a stored energy level that may satisfy the usage limit based on the user device usage pattern. The mobile devices may represent vehicles and the task may represent traveling to a destination location. The identifying may further comprise identifying, as a candidate vehicle, one or more available vehicles that may include a total stored energy sufficient to reach the destination location based on the user device usage pattern and energy depletion rates of the corresponding available vehicles.

Optionally, the mobile devices may represent portable handheld devices and the task may represent operating the mobile device for a designated period of time. The identifying may further comprise identifying, as a candidate handheld device, one or more of available handheld devices that may include a total stored energy sufficient to operate for the designated period of time based on the user device usage pattern and energy depletion rates of the corresponding available handheld devices. The method may further comprise calculating a route between starting and destination locations, wherein the usage limit may be based on the route. The usage limit may include a total distance between the starting and designated destinations. The method may further comprise calculating the total distance based on the route.

Optionally, the method may further comprise calculating the user device usage pattern based on historic energy consumption by the user and may save the user device usage pattern in the user profile. At least a portion of the available mobile devices may exhibit first and second energy depletion rates. The method may further comprise selecting between the first and second energy depletion rates based on the user device usage pattern and may determine whether the corresponding available mobile devices include a stored energy level sufficient to satisfy the usage limit based on the selected one of the first and second energy depletion rates. The method may receive device usage data associated with a device sharing task, and may calculate an update to the user profile based on the device usage data. The method may receive device usage data associated with a returned mobile device, and may calculate an energy depletion rate associated with the corresponding returned mobile device.

In accordance with embodiments herein a system is provided. The system comprises a processor, and a memory storing instructions accessible by the processor. Responsive to execution of the instructions, the processor obtains a user profile that includes a user device usage pattern associated with a user, receives a usage limit associated with a task and identifies a candidate mobile device from a pool of available mobile devices based on the usage limit and the user device usage pattern.

Optionally, the processor may identify, as the candidate mobile devices, one or more of the available mobile devices that may have a stored energy level that may satisfy the usage limit based on the user device usage pattern. The mobile devices may represent vehicles. The processor may identify, as a candidate vehicle, one or more of available vehicles that may include a total stored energy sufficient to reach the destination location based on the user device usage pattern and energy depletion rates of the corresponding available vehicles.

Optionally, the mobile devices may represent portable handheld devices. The processor may identify, as the candidate mobile device, one or more of available mobile devices that may include a total stored energy sufficient to operate for a total amount of time based on the user device usage pattern and energy depletion rates of the corresponding available mobile device. The processor may calculate a route between starting and destination locations. The usage limit may be based on the route. The usage limit may include a total distance between the starting location and the designated destination. The processor may calculate the total distance based on the route.

In accordance with embodiments herein a computer program product is provided comprising a non-signal computer readable storage medium comprising computer executable code to obtain a user profile that includes a user device usage pattern associated with a user, receive a usage limit associated with a task and identify a candidate mobile device from a pool of available mobile devices based on the usage limit and the user device usage pattern.

Optionally, the computer program product may further comprise a computer executable code may calculate the user device usage pattern based on historic energy consumption by the user associated saved in the user profile. At least a portion of the available mobile devices may include first and second energy depletion rates. The computer executable code may select between the first and second energy depletion rates based on the user device usage pattern and determine whether the corresponding available mobile device include a stored energy level sufficient to satisfy the usage limit based on the selected one of the first and second energy depletion rates. Computer executable code may receive device usage data associated with a device sharing operation, and calculate an update to the user profile based on the device usage data.

### BRIEF DESCRIPTION OF THE DRAWINGS

FIG. 1A illustrates a block diagram of a vehicle share management system formed in accordance with an embodiment herein.

FIG. 1B illustrates a block diagram of a mobile device share management (MDSM) system formed in accordance with an embodiment herein.

FIG. 2 illustrates a process carried out by one or more VIM stations, MDIM stations, SM servers, kiosk, portable devices, workstations and the like in accordance with embodiments herein.

FIG. 3 illustrates a process for identifying candidate device (vehicle or non-vehicle) from a pool of available devices in accordance with embodiments herein.

FIG. 4 illustrates a process for updating user profiles in accordance with an embodiment herein.

FIG. 5 illustrates an example screenshot presented on a computing device in accordance with an embodiment herein.

FIG. 6 illustrates example screenshots presented on a computing device in accordance with an embodiment herein.

FIG. 7 illustrates a portion of a database that may be maintained by a VIM station and/or the SM server in accordance with embodiments herein.

FIG. 8 illustrates a simplified block diagram of internal components of the electronic device configured in accordance with embodiments herein.

### DETAILED DESCRIPTION

It will be readily understood that the components of the embodiments as generally described and illustrated in the FIGS. herein, may be arranged and designed in a wide variety of different configurations in addition to the described example embodiments. Thus, the following more detailed description of the example embodiments, as represented in the FIGS., is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “vehicle” is used to refer to any types of machine or device utilized in connection with transportation that is at least partially powered by an energy source. For example, a vehicle may represent an automobile (e.g., car, SUV, truck, etc.), a motorcycle, moped, hover board, electric assisted bicycles, boats, airplanes, gliders, golf cart and the like. The vehicle may be powered with various types of energy, such as gasoline, diesel, electric and the like.

The term “mobile device” is used to refer to any type of mobile electronic device. The term mobile device shall also be used to encompass “vehicles”, and shall also include non-vehicle electronic devices, such as portable handheld devices. Examples of portable handheld devices include smart phones, tablet devices, computers, electronic games, portable home appliances and the like.

The terms “energy” and “fuel” are used interchangeably to refer to any and all energy sources utilized by vehicles, including (but not limited to) gasoline, diesel fuel and any other fossil fuels, as well as any and all electric power sources, whether A.C., D.C., or otherwise. The terms “energy” and “fuel” include nuclear power, solar power, wind power, as well as any other renewable energy sources, and the like.

The term “usage planning information” is used to refer to any and all information regarding use of a mobile device. In connection with vehicles, the usage planning information may include trip planning information such as (but is not limited to) start location, destination location, route information, a number of individuals traveling, a time of day during which travel occur, an intended use of the vehicle (e.g., a plan to call a predetermined amount of payload) and the like. In connection with non-vehicle mobile devices, the usage planning information may indicate a task to be performed, an amount of operative time, applications to be implemented on the mobile device and any other type of information representative of demands that will be placed on the energy source of the mobile device. By way of example, an intended use of a vehicle may indicate the need to tow a certain size load, a need for a topper or exterior luggage rack (e.g., for skis, bicycles, etc.). As explained herein, the system may limit suggested candidate vehicles to available vehicles that are approved to tow the indicated size of load, have sufficient seating for the designated number of passengers, have a luggage rack, etc.

The term “user profile” refers to a collection of information that is maintained and updated regarding an individual user, group of users, business account and the like. The user profile includes a user device usage pattern indicative of past behavior associated with the user or user account. For example, the user device usage pattern may indicate whether the user is an aggressive driver or a passive driver, an extent to which the user utilizes secondary energy demands within the vehicle (e.g., heater, air-conditioning, accessories, chargers within the vehicle). The user device usage pattern may indicate a driving style and/or an energy usage pattern. A user profile may also indicate preferences, such as whether the user prefers particular types of vehicles (e.g., sedan v. 2-door cars, truck v. SUV, etc.). In connection with the non-vehicle mobile devices, the user device usage pattern may indicate a rate at which the user drains battery of a mobile device, an amount of time the user utilizes wireless service, an amount of time the user streams video content to the device and the like.

The terms “energy use rate” and “energy use rates” refer to a rate or rates at which an individual mobile device (vehicle or non-vehicle) uses energy. For example, the energy use rate for a vehicle may refer to the highway and/or city mileage rating of a vehicle. The mileage rating may be based on miles per gallon (MPG), miles per gallon equivalent (MPGe), kilowatt hours (KW) per 100 miles, KW per 100 kilometers and any other standard rating metric. As another example, the energy use rate for a non-vehicle mobile device may refer to a rate at which the device drains battery when performing different types of processing operations (e.g., operating basic word processing tools, streaming video content, maintaining a wireless Internet connection).

The term “usage limit” refers to one or more limiting parameters to be satisfied to meet a task indicated by usage planning information. The task may correspond to traveling to a destination location, utilizing a mobile device (vehicle, portable handheld device or other mobile device) for a designated amount of time, utilizing a mobile device to perform a designated operation and the like. The usage limit may be calculated based on other usage planning information. For example, the usage limit may include a total distance along a route automatically calculated between starting and destination locations. The usage limit may include a total energy, total time, etc., to travel along the calculated route. Additionally or alternatively, the usage limit may be directly entered by the user, such as by entering a total distance to be traveled, a total time for which the vehicle should be operative, a total amount of energy that the vehicle should initially include (e.g., a full tank of gas, a fully charged battery, 200 KWH of charge, 10 gallon of fuel). As another example, the usage limit for a non-vehicle mobile device may refer to a maximum amount of time that the mobile device will operate based on batteries in connection with different types of processing operations.

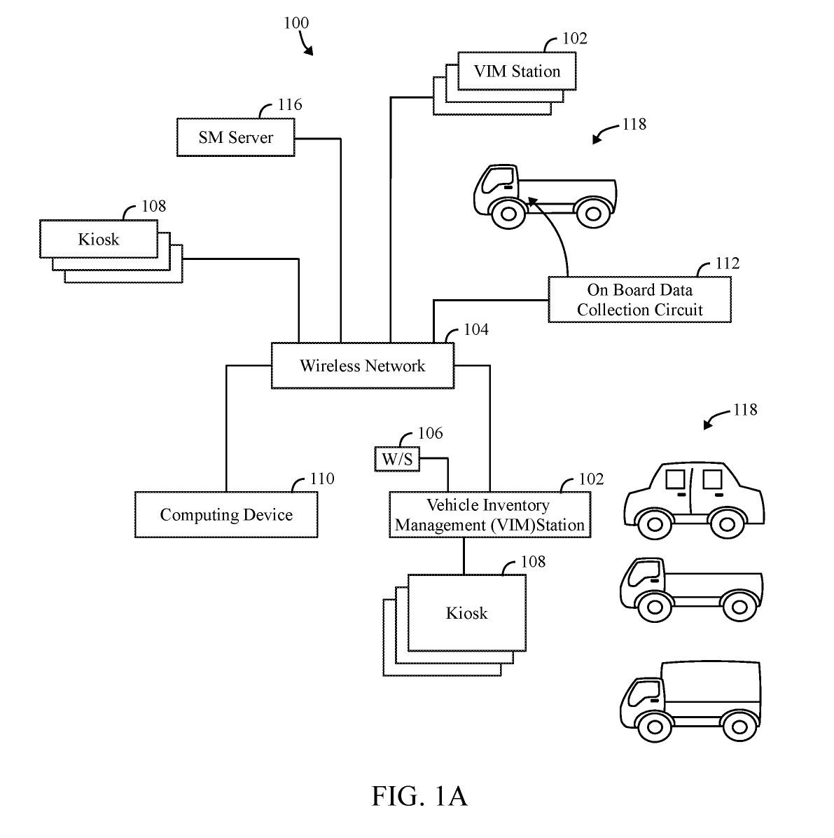

FIG. 1A illustrates a block diagram of a vehicle share management system 100 formed in accordance with an embodiment herein. The system 100 includes one or more vehicle inventory management (VIM) stations 102 that are geographically distributed over a region for which the system 100 manages vehicle sharing. For example, the VIM stations 102 may be distributed over a campus (e.g., college campus, corporate campus, healthcare campus), city, county, state, country or any other geographic region for which a common vehicle sharing system is to be implemented. The VIM stations 102 may manage one or more pools of available vehicles that are located at various discrete locations. For example, a VIM station 102 may be located at a location where a pool or group of available vehicles are stored. The users periodically drop-off and pickup vehicles at the VIM stations 102 and thus the inventory at a particular VIM station 102 continuously changes. By way of example, the VIM stations 102 may be located at various locations across a college or business campus, distributed throughout a city, located at airports and other public transportation sites, as well as at other sites. Non-limiting examples of implementations include pools of car, moped and/or power assisted bicycles distributed across a college campus, automobile fleets distributed between airports across the United States and outside the United States, etc.

The VIM stations 102 communicate over one or more networks 104 with one another, with kiosks 108, computing devices 110, and/or one or more SM servers 116. The network 104 may comprise the Internet, one or more cellular networks, private or public local area networks, private or public wide area networks and the like. The VIM stations 102 may receive/send communications over wired or wireless links. The VIM stations 102 may include workstations 106 operated by authorized personnel, customers and/or end-users. The kiosks 108 are configured to receive information directly from customers and end users to allow quick and efficient vehicle drop-off and pickup. As another example, customers and end-users may use personal computing devices 110 to communicate with the system 100. For example, the computing devices 110 and kiosks 108 may be used to access a user's individual account to request and reserve a vehicle from a VIM station 102. The computing devices 110 and kiosks 108 allow individual users to order, select, drop-off and otherwise manage individual vehicles within the pool of available vehicles 118. Non-limiting examples of electronic devices 110 include smart phones, tablet devices, desktop computers, and laptop computers.

Optionally, individual onboard data collection circuits 112 may be provided as an onboard system that is communicatively coupled to a vehicle onboard computer. The data collection circuits 112 may track various data and information (collectively vehicle use data) of interest in connection with a mobile device sharing task. For example, the data collection circuits 112 may collect, as the vehicle used data, initial and final mileage, initial and final energy levels, initial and final hours of operation and the like. The data collection circuits 112 may also collect other information related to individual user behavior, such as driving patterns. The data collection circuits 112 convey the vehicle used data to a VIM station 102 and/or SM server 116 when the vehicle is checked into a VIM station, when a vehicle is checked out of a VIM station or any other point there between. Additionally or alternatively, the data collection circuits 112 may store energy profiles in connection with the corresponding vehicle, such as the current amount of energy stored therein, as well as one or more energy depletion rates exhibited by the vehicle in accordance with different criteria or factors.

In accordance with embodiments herein, the system 100 allows individual users to choose from a pool of available vehicles when traveling between a start location (corresponding to one VIM station) to a destination location (corresponding to another VIM station). A VIM station 102 receives usage planning information (e.g., trip planning information) and a user identification from a user. From the usage planning information, the VIM station 102 calculates one or more usage limits associated with a task. The task may represent traveling to a destination location. The task may also represent utilizing a vehicle, portable handheld device, etc., for a predetermined period of time. The usage limits may represent trip limits, time limits, processing power limits, and the like. The VIM station 102 and identifies one or more candidate vehicles from the pool of available vehicles that would be able to satisfy the usage limits (e.g., reach the designated destination without the need to refuel or recharge). The candidate vehicles identified based in part on the usage limits and based on a user device usage pattern associated with the user profile of the present user. For example, the candidate vehicles may be identified as one or more of the available vehicles that have a stored energy level that is sufficient to satisfy the usage limits, when factoring in the user device usage pattern. For example, when the usage limit corresponds to a distance between the start location and a designated destination, the VIM station 102 would identify the vehicles having sufficient gas or battery charge to travel the distance without the need to refill or recharge the vehicle.

FIG. 1B illustrates a block diagram of a mobile device share management (MDSM) system 150 formed in accordance with an embodiment herein. The system 150 includes one or more mobile device inventory management (MDIM) stations 152 that are geographically distributed over a region for which the system 150 manages device sharing. For example, the MDIM stations 152 may be distributed over a building, campus (e.g., college campus, corporate campus, healthcare campus), city, office space or any other geographic region for which a common device sharing system is to be implemented. The MDIM stations 152 may manage one or more pools of available mobile devices 168 that are located at various discrete locations. For example, a MDIM station 152 may be located at a location where a pool or group of available mobile devices 168 are stored. The users periodically drop-off and pickup devices at the MDIM stations 152 and thus the inventory at a particular MDIM station 152 continuously changes. By way of example, the MDIM stations 152 may be located at various locations across a college or business campus or building, as well as at other sites.

The MDIM stations 152 communicate over one or more networks 154 with one another, with kiosks 158, computing devices 160, and/or one or more MDSM servers 166. The network 154 may comprise the Internet, one or more cellular networks, private or public local area networks, private or public wide area networks and the like. The MDIM stations 152 may receive/send communications over wired or wireless links. The MDIM stations 152 may include workstations 156 operated by authorized personnel, customers and/or end-users. The kiosks 158 are configured to receive information directly from customers and end users to allow quick and efficient device drop-off and pickup. As another example, customers and end-users may use personal computing devices 160 to communicate with the system 150. For example, the computing devices 160 and kiosks 158 may be used to access a user's individual account to request and reserve a device from a MDIM stations 152. The computing devices 160 and kiosks 158 allow individual users to order, select, drop-off and otherwise manage individual devices within the pool of available devices. Non-limiting examples of electronic devices 160 include smart phones, tablet devices, desktop computers, and laptop computers.

Optionally, individual onboard data collection circuits 162 may be provided as an onboard system that is communicatively coupled to one or more processors of the mobile devices 168. The data collection circuits 162 may track various data and information (collectively mobile device use data) of interest in connection with a mobile device sharing task. For example, the data collection circuits 162 may collect, as the mobile device used data, initial and final energy storage levels, initial and final hours of operation, and the like. The data collection circuits 162 may also collect other information related to individual user behavior, such as an amount of processing power utilized, amount of time spent streaming video, amount of time utilizing wireless connections, a brightness level used with the display and the like. The data collection circuits 162 convey the mobile device used data to a MDIM station 152 and/or SM server 166 when the mobile device is checked into a MDIM station, when a mobile device is checked out of a MDIM station or any other point there between. Additionally or alternatively, the data collection circuits 112 may store energy profiles in connection with the corresponding mobile device, such as the current amount of energy stored therein, as well as one or more energy depletion rates exhibited by the mobile device in accordance with different criteria or factors.

In accordance with embodiments herein, the system 150 allows individual users to choose from a pool of available devices to use for a select application or period of time. A MDIM station 152 receives usage planning information and a user identification from a user. From the usage planning information, the MDIM station 152 calculates one or more usage limits associated with a destination application. The MDIM station 152 and/or MDSM server 166 identifies one or more candidate devices from the pool of available devices that would be able to satisfy the usage limits (e.g., reach the designated destination without the need to refuel or recharge). The candidate device is identified based in part on the usage limits and based on a user device usage pattern associated with the user profile of the present user. For example, the candidate device may be identified as one or more of the available devices that have a stored energy level that is sufficient to satisfy the usage limits, when factoring in the user device usage pattern. For example, when the usage limit corresponds to a time of use, the MDIM station 152 would identify the devices having sufficient battery charge to operate for the designated time interval without the need to recharge the device.

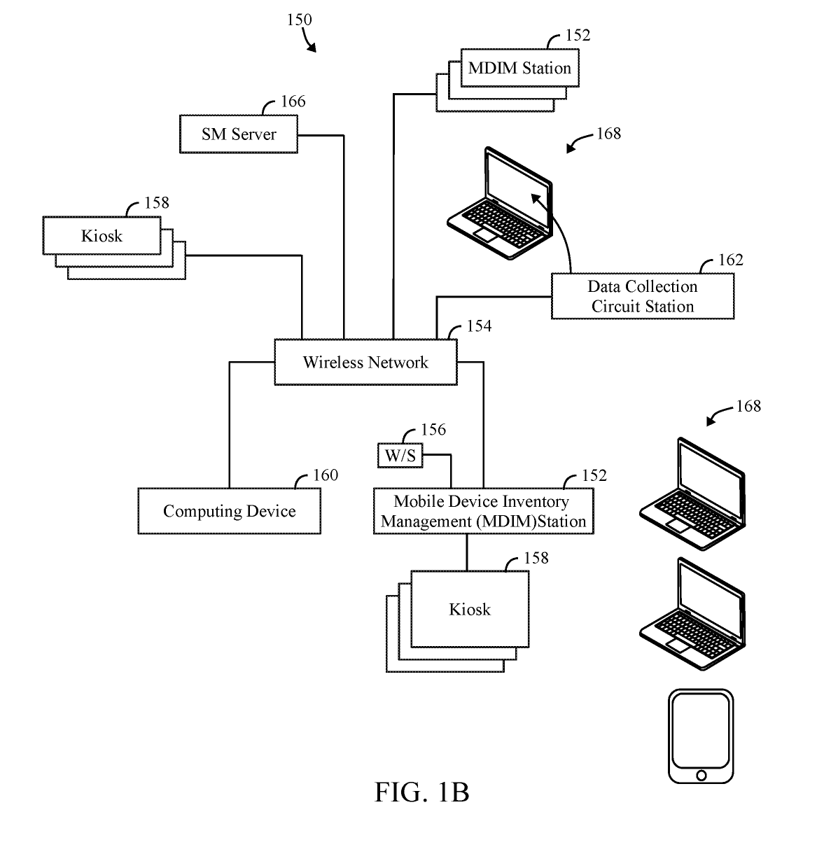

FIG. 2 illustrates a process carried out by one or more VIM stations, MDIM stations, SM servers, kiosk, portable devices, workstations and the like (FIGS. 1A and 1B). The operations of FIG. 2 are carried out by one or more processors executing program instructions stored in memory. The operations of FIG. 2 may be distributed between the processors within one or more VIM stations, MDIM stations, SM servers, kiosk, portable devices, workstations and the like, and may be carried out in various orders.

At 202, one or more processors receives a user identification (ID) and usage planning information. For example, the user ID and/or usage planning information may be entered by a user at a kiosk 108 and/or from an electronic device 110, 160 (FIGS. 1A and 1B). Additionally or alternatively, the user ID and/or usage planning information may be entered at a workstation 106, 156 by an authorized individual. The user ID and usage planning information may be entered at different times or the same time. As one example, a user may open a share management application (e.g., vehicle or device share management application) stored on the electronic device 110, 160 and enter usage planning information for a particular usage. The usage planning information may include a starting location corresponding to a VIM station 102 or MDIM station 152. Additionally or alternatively, the user may enter a starting location (or the present location of the electronic device 110 may be used as the starting location). The electronic device 110, 160 may utilize the user's present location or a user designated start location to identify the closest VIM station 102 and/or MDIM station 152. The electronic device 110, 160 may then offer the closest VIM station 102 or MDIM station 152, or offer a list of relatively close VIM stations 102 or MDIM stations 152, for the user to select. Once the user selects a particular VIM station 102 or MDIM station 152, the chosen VIM station 102 or MDIM station 152 is used as the starting location, along with additional usage planning information entered by the user.

In accordance with one embodiment, the user profile may be maintained on the electronic device 110, 160. Additionally or alternatively, the user profile may be maintained at one or more VIM stations 102, MDIM stations 152, and/or SM server 116, 166. When the user profile is maintained remote from an electronic device 110, 160, the electronic device 110, 160 sends the user ID alone or in combination with the usage planning information to the VIM station 102, MDIM station 152 and/or SM server 116, 166 that maintains user profiles. The user ID may be stored in a electronic device 110, 160 (e.g., a cellular phone, laptop computer and the like), with the electronic device 110, 160 automatically conveying the user ID to a select station 102, 152 and/or SM server 116, 166 when the user opens the SM application on the electronic device 110, 160 and enters the usage planning information. The SM application may step through one or more Windows to prompt the user for various usage planning information through a local application operating on the computing device. Additionally or alternatively, the SM application may represent a web browser based session supported by a resource at the server 116, 166 and/or station 102, 152. When a web browser based session is utilized, the electronic device 110, 160 may simply display information from the server 116, 166 and/or station 102, 152 and collect inputs from the user to be conveyed back to the server 116, 166 and/or station 102, 152. The electronic device 110, 160 may also convey the user profile and/or user ID automatically when a web browser based session is initiated.

At 204, the one or more processors accesses memory to obtain a user profile associated with the user ID. For example, the user profile may be maintained locally in memory on the electronic device 110, 160. Additionally or alternatively, the user profile may be contained in a database or other collection of user profiles in memory at the server 116, 166 and/or station 102, 152. Examples are provided herein regarding the various types of information that may be maintained within a user profile.

At 206, the one or more processors identifies the available mobile devices that may be used. For example, when the operation at 206 is performed at station 102, 152, the station 102, 152 maintains a local inventory of available vehicles that is utilized at 206. Additionally or alternatively, the operation at 206 may be performed at the server 116, 166. The server 116, 166 may receive a selection of a station 102, 152 (e.g., directly designated by the user or automatically chosen as the closest station 102, 152 to a starting location). Once the server 116, 166 determines the station 102, 152, the server 116, 166 may access an inventory of available vehicles stored in connection with the station 102, 152. The inventory of available vehicles may be maintained at the server 116, 166 and/or provided to the server 116, 166 from the station 102, 152.

At 206, any and all vehicles or devices within the pool associated with a station 102, 152 (and not reserved or otherwise checked out by other users) may be identified. Optionally, a subset of the total pool of the vehicles or devices may be identified as the available vehicles or devices based on information in the user profile and/or usage planning information. For example, a user's profile may indicate that the user only prefers to use cars, and not SUVs or trucks. In the present example, all trucks and SUVs would be eliminated from the available vehicle list. As another example, travel planning information may indicate that multiple people are traveling in the vehicle and/or the vehicle is intended to tow a certain payload. In the present example, vehicles would be eliminated that are unable to carry the designated number of people and/or vehicles unable to tow the designated payload.

At 208, the one or more processors determines energy profiles for the available vehicles or devices identified at 206. The energy profile may indicate a total energy stored in the vehicle or device (e.g., a total amount of gas in the tank, a total battery storage). The energy profile may also indicate the energy usage rates associated with the vehicle or device. For example, the energy profile may indicate a first energy usage rate in connection with city driving and a second energy usage rate in connection with highway driving. As another example, the energy profile may indicate a first energy usage rate in connection with aggressive drivers in a second energy usage rate in connection with passive drivers. As another example, the energy profile may indicate a supplemental energy usage rate associated with excessive use of internal vehicle accessories. For example, when the air-conditioning, heating, internal charters and the like are utilized more than above a predetermined threshold, a supplemental energy usage rate may be added to the first or second energy usage rate. For example, when the vehicle is used in city driving and the air conditioner is continuously used all day at a high level (while in a hot climate), the mileage per gallon associated with the city MPG rating may be reduced by one-three additional miles per gallon as a supplemental energy usage rate. As another example, on a mobile device, the energy profile may indicate a first energy rate when the device is operated with a high brightness.

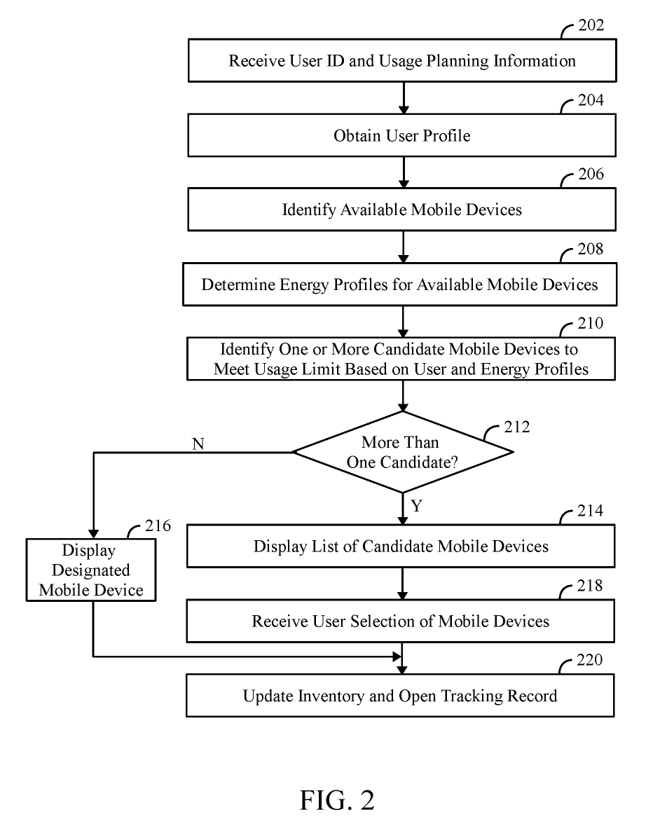

At 210, the one or more processors identify one or more candidate vehicles or devices that meet a target based on the user profile and the energy profiles of the available vehicles or device. The operations at 210 are discussed below in more detail in connection with FIG. 3.

At 212, the one or more processors determines whether more than one candidate device (vehicle or non-vehicle) has been identified. When more than one candidate device is identified, flow moves to 214. Otherwise, flow moves to 216. At 216, the user is presented with information concerning the one candidate device. For example, the information may be displayed on the electronic device 110, 160, a kiosk 108, 158, the workstation 106, 156 or otherwise. The information displayed may designate the make model and year of the vehicle, a total energy stored in the device, the energy usage rating of the vehicle, as well as any other information of interest. The displayed information may also inform the user of a location of the device, such as a row and parking location within a parking lot area, a storage bay in mobile cart and the like. At 216, the user is allowed the opportunity to confirm acceptance of the available device, after which flow moves to 220.

Returning to 212, when more than one candidate device is identified, flow moves to 214. At 214, a list of candidate device (vehicle or non-vehicle) are displayed to the user and the user is afforded the option to select from the list of candidate devices. At 218, the one or more processors receives the user selection of one of the candidate devices. Thereafter, flow advances to 220.

At 220, the one or more processors updates the inventory of available device (vehicle or non-vehicle) to indicate that the chosen device has been removed from the available inventory. In addition, a tracking record may be opened in connection with the selected device. The tracking record may include tracking information, such as to record an estimated date, time and location to which the device is to be returned. The tracking record may also record the mileage on the device, as well as the present total energy stored therein (e.g., current battery charge, current gallons of fuel, etc.).

Hereafter, the operations and features of FIGS. 3-8 are described in connection with a vehicle sharing system. Additionally or alternatively, the operations and features of FIGS. 3-8 may be implemented in connection with a non-vehicle mobile device.

FIG. 3 illustrates a process for identifying candidate device (vehicle or non-vehicle) from a pool of available devices (corresponding to the operation at 210 in FIG. 2). The operations of FIG. 3 may be distributed between the processors within one or more stations, server, kiosk, portable devices, workstations and the like, and may be carried out in various orders.

At 302, one or more processors determines whether the usage planning information includes a usage limit directly entered by the user. As noted herein, the user may directly indicate a usage limit, to be satisfied by the vehicle (e.g., total travel distance, total travel time, total fuel/energy). For example, within the usage planning information, the user may merely indicate a desire to utilize a device for a predetermined period of time (e.g., for the next two-three hours). Additionally or alternatively, the usage planning information may indicate that the user desires to utilize the vehicle for a predetermined distance (e.g., 200-300 miles). When the usage limit is directly entered in the usage planning information, flow branches to 308. Otherwise, flow advances to 304.

At 304, one or more processors calculates a route suggested to be utilized by the vehicle. The route may be calculated based on start and destination locations included within the usage planning information. The route calculation may be performed in accordance with various conventional route calculation algorithms. Additionally or alternatively, the route may be calculated, partially automatically and partially based on input from the user. For example, the user may be presented with a suggested route, and then afforded the option through a graphical user interface to modify one or more segments of the desired route (e.g., by selecting and dragging points along a proposed route to alternative route segments).

At 306, one or more processors determines a usage limit based on the route. For example, the usage limit make correspond to the total distance traveled and/or estimated total time to travel over the route.

Next, the operations at 308-316 iteratively step through each available vehicle to identify one or more candidate vehicles. At 308, one of the available vehicles is selected. The selection at 308 may include an initial filter to remove vehicles that do not satisfy preferences within a user profile or secondary usage limits. For example, a user profile may indicate that an individual user does not desire to utilize trucks, and thus at 308, all available trucks would be removed from the pool of vehicles to be considered in the operations at 308-316. As another example, the usage planning information may indicate that the intended use includes carrying for passengers and thus at 308, all vehicles that are unable to carry for passengers would be removed from the pool of vehicles to be considered. As another example, when the usage planning information indicates that a certain payload is to be towed (e.g., pulling a trailer with a certain weight limit), all vehicles would be removed that do not include tow hitches and are not rated to pull the designated size/weight trailer.

At 310, the one or more processors reviews and energy profile associated with a currently selected vehicle. The energy profile includes the total stored energy within the vehicle and optionally may include one or more energy depletion rates exhibited by the vehicle. For example, the total stored energy may correspond to the amount of fuel in the gas tank, the amount of charge in the batteries and the like. The energy depletion rates may correspond to different ratings at which the vehicle uses energy based on certain driving conditions (e.g., city versus highway MPG, MPGe, etc.). Additionally or alternatively, energy depletion rates may be designated for particular types of users (e.g., passive, aggressive, etc.).

At 312, the one or more processors selects one of the energy depletion rates based on the user profile. For example, when a user profile designates a user to be an aggressive driver, the energy depletion rate may be chosen that corresponds to city driving, even though all or a portion of the route may include highways. As another example, when a user profile designates a user to be a passive driver, the energy depletion rate may be chosen that corresponds to highway driving, even though all or a portion of the route may include city streets.

Optionally, when a vehicle only includes a single standard energy depletion rate, at 312, the standard energy depletion rate may be adjusted based on the user profile. For example, the standard energy depletion rate may be increased for aggressive drivers or decreased for passive drivers. Additional or alternative mechanisms may be utilized to identify energy depletion rates and make adjustments therein based on the energy profile for a vehicle and a user profile.

At 314, the one or more processors calculates and saves a vehicle range associated with the currently selected vehicle. The vehicle range may correspond to a total miles, total time or other indicator of a capacity of the vehicle based on the current energy profile of the vehicle. The type of vehicle range that is calculated is based on the travel limit. For example, when the travel limit designates a total distance to be traveled, the vehicle range is also calculated in total distance. When the travel limit corresponds to a total operational time, the vehicle range is also calculated in terms of total operational time.

At 316, the one or more processors determines whether the vehicle range calculated at 314 for the currently selected vehicle satisfies or exceeds the usage limited. For example, the determination is made as to whether the currently selected vehicle has sufficient fuel or energy to travel a total distance or time defined by the usage limit. When the vehicle range satisfies or exceeds the travel limit, flow moves to 318. Otherwise, flow returns to 320. At 318, the one or more processors adds the currently selected vehicle to a candidate list of vehicles that are able to satisfy the usage limit. Thereafter, flow moves to 320.

At 320, the one or more processors determines whether additional vehicles are available in the pool to be considered in connection with the present usage limit. If so, flow returns to 308. Otherwise, the process ends and the list of vehicle candidates saved at 318 is returned to the process of FIG. 2 at 210. Optionally, the process of FIG. 3 may not be iterative. Instead, the first vehicle is identified to satisfy the travel limit may be returned as the only candidate vehicle.

Additionally or alternatively, the operations FIG. 3 may be implemented in connection with a non-vehicle mobile device.

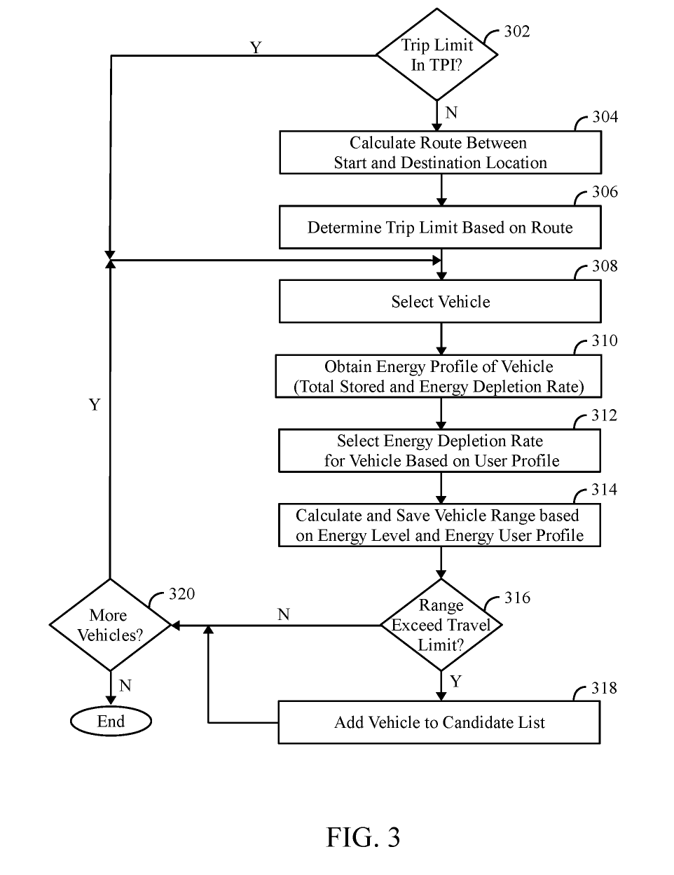

FIG. 4 illustrates a process for updating user profiles in accordance with an embodiment herein. The operations of FIG. 4 may be distributed between the processors within one or more VIM stations, MDIM stations, SM server, kiosk, portable devices, workstations and the like, and may be carried out in various orders. The operations of FIG. 4 are described as being implemented at the time when a user drops off or checks in a previously used vehicle. Additionally or alternatively, all or a portion of the operations of FIG. 4 may be performed at other times separate from dropping off or checking in used vehicles. The operations of FIG. 4 are performed in connection with completion of a device sharing task, such as when a user returns a vehicle or other mobile device, generally referred to as a returned mobile device

At 402, one or more processors receives check-in data associated with a most recent device sharing task for a returned mobile device (e.g., vehicle, portable handheld device, etc.). For example, the check-in data may represent vehicle check-in data that includes a vehicle identifier (e.g., a VIN number) or other unique designator for the vehicle. The check-in data is utilized to access records associated with the vehicle or other mobile device. At 404, one or more processors obtains device usage data associated with the device sharing task. For example, the device usage data may include the start time and/or start location at which the vehicle was previously checked out by a current user. The device usage data may also include the initial/start amount of fuel in the vehicle, the start charge level for an electric vehicle, a total start mileage for the vehicle, a start clock for total operational time of the vehicle (when picked up) and the like. The device usage data also includes end time and destination location information, at which the vehicle was dropped off. For example, the device usage data may also include a final amount of fuel in the vehicle, a final charge level for an electric vehicle, a total final mileage for the vehicle, a final clock for total operational time of the vehicle (at the time dropped off) and the like. Optionally, additional device usage data may be collected, such as the amount of time that the air-conditioning or he was operated, an amount to which accessories within the vehicle were used, an amount of time or energy drawn through charging interfaces within the vehicle and the like. Additional device usage data may include driving behavior related information, such as the average rate of speed, the number of times a driver accelerated or decelerated at rates above predetermined thresholds, and other drive behavior related information. Device usage data related to portable handheld devices may include an amount of time that the user uses wireless services (e.g., WiFi, Bluetooth, etc.), a display brightness that the user prefers, etc.

At 406, one or more processors updates the vehicle energy profile. For example, the energy profile may be updated by recording, in a record associated with the vehicle, the current level of fuel or energy in the vehicle. In addition, the energy profile may be updated by adjusting one or more energy depletion rates associated with the vehicle. For example, a vehicle may initially be assigned standard highway and city energy depletion ratings. However, over time, the actual energy depletion ratings of the vehicle may differ from the standard rating. By collecting vehicle usage data, energy depletion ratings may be updated to more accurately reflect a current status of the vehicle (e.g., the vehicles actual city MPG, Highway MPG, etc.).

At 408, the one or more processors calculates updates for the user profile based on the use data. The updates include updates to historic energy consumption by the user. For example, the vehicle usage data may indicate that the user traveled a relatively large distance in a period of time that is shorter than an allotted period of time for a vehicle traveling at the appropriate speed limits. When the vehicle usage data indicates that a user exhibits a tendency to speed or exhibits another driving style characteristic, the user profile may be updated to designate the user device usage pattern as an aggressive driver. As another option, when the vehicle usage data indicates that the user covered the route in an amount of time corresponding to the appropriate speed limits, the user profile may be updated to designate the user device usage pattern as a passive driver. As other examples, when the vehicle is returned with less or more fuel or energy than expected based on the distance traveled, the user profile may be updated by designating the users energy usage pattern as an aggressive or passive driver, respectively. At 410, the users profile is updated, such as by updating the users energy usage pattern and/or other aspects of the historic energy consumption by the user. Optionally, the user profile may retain multiple user device usage patterns for the associated user, where each of the user device usage patterns is associated with a particular criteria or factor (e.g., region of usage, personal v. business usage, time of day, length of usage). The collection of one or more user device usage patterns form at least a part of the user's historic energy consumption.

Additionally or alternatively, the operations and features of FIG. 4 may be implemented in connection with a non-vehicle mobile device.

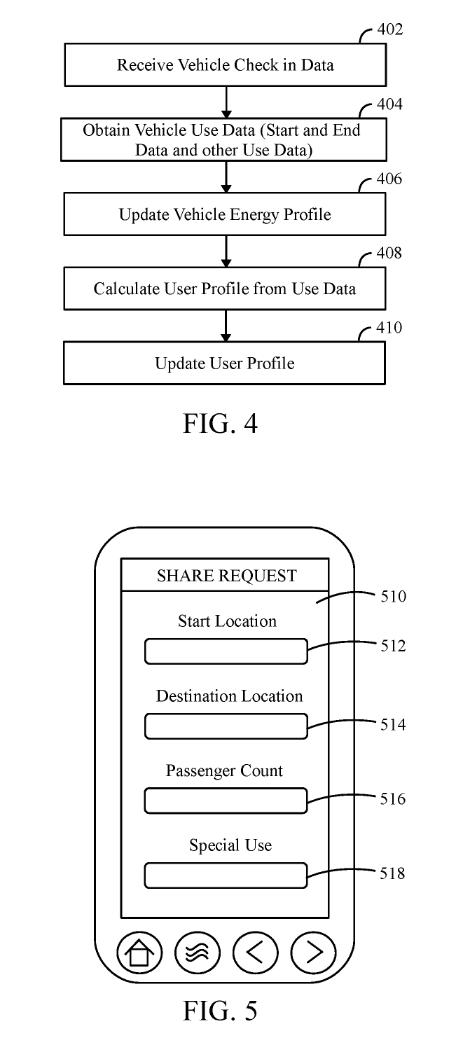

FIG. 5 illustrates an example screenshot presented on a computing device in accordance with an embodiment herein. The computing device 110 includes a vehicle share management (SM) application stored thereon. The SM application may be activated when a user desires to schedule a device sharing task. When the SM application is opened, the user may navigate to a share request screen 510. The share request screen 510 may present various fields to the user, at which user enters usage planning information. For example, the share request screen 510 may include start and destination location fields 512, 514. The start location field 512 indicates a starting point for the usage, while the destination location 514 indicates the final destination for the usage. Optionally, the start location may be automatically designated as the present location of the electronic device 110. The share request screen 510 may also present a passenger count field 516, at which the user may enter the number of people traveling on the usage. The share request screen 510 may also include a special use field 518 at which special intended uses may be entered. For example, a special use may indicate the need for a luggage or bicycle rack on the vehicle, a need to tow a trailer with a certain size/weight, and the like.

Optionally, the fields of the screens illustrated in FIG. 5 may be modified to include information related to non-vehicle mobile devices.

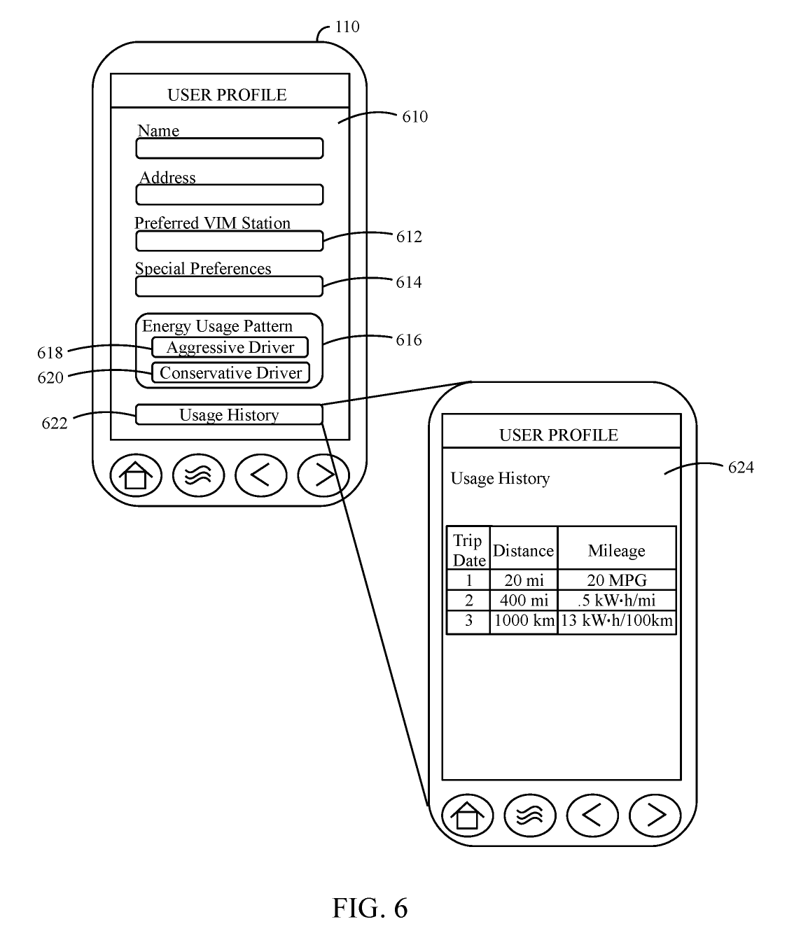

FIG. 6 illustrates example screenshots presented on a computing device in accordance with an embodiment herein. When the SM application is opened, the user may navigate to a user profile associated with the present user. The user profile may be stored on the computing device 110, and/or maintained elsewhere within the system 100. A user profile screen 610 is presented on a graphical user interface of the electronic device 110. The user profile screen 610 may present fields for various background information, such as name and address. In addition, the user profile screen 610 may present preference fields that may be designated by the user. For example, a preferred VIM station field 612 may be provided with the user profile, to allow the user to designate one or more particular VIM stations that the user repeatedly utilizes. Additionally or alternatively, a special preference field 614 may be provided to allow the user to enter particular preferences. For example, a user may indicate a preference for certain types of vehicles (e.g., electric, nonelectric, trucks, four-door cars, etc.). The user profile screen 610 also illustrates an energy usage pattern field 616 that is associated with the user. The energy usage pattern field 616 may designate the user to be an aggressive driver 618 and/or a passive driver 620. In accordance with some embodiments, the user may be allowed to characterize themselves by selecting one of the aggressive and conservative driver entries 618, 620. Additionally or alternatively, the system 100 may automatically update the energy usage pattern within the field 616 based on actual usage data. When an energy usage pattern is to be updated based on actual use, the update may first be presented to the user and the user requested to confirm the modification. Alternatively, the energy usage pattern may be automatically updated without affording the user the option to accept the update.

Optionally, the user profile screen 610 may present a usage history icon 622. When the usage history icon 622 is selected, a usage history screen 624 may be presented. The usage history screen may display various information concerning past vehicle usage. For example, the usage history may list usage dates, distances, the mileage achieved by the vehicle over the usage (e.g., 20 miles per gallon, 0.5 KWH per mile, 13 KWH per 100 km). The usage history may include additional information, such as the VIM station locations, types of vehicles utilized and the like.

While the screens described in connection with FIGS. 5 and 6 are discussed relative to the electronic device 110, it is recognized that the screens may be presented on other devices within the system 100, such as on kiosks, workstations, the VIM stations and the like. Optionally, the fields of the screens illustrated in FIG. 6 may be modified to include information related to non-vehicle mobile devices.

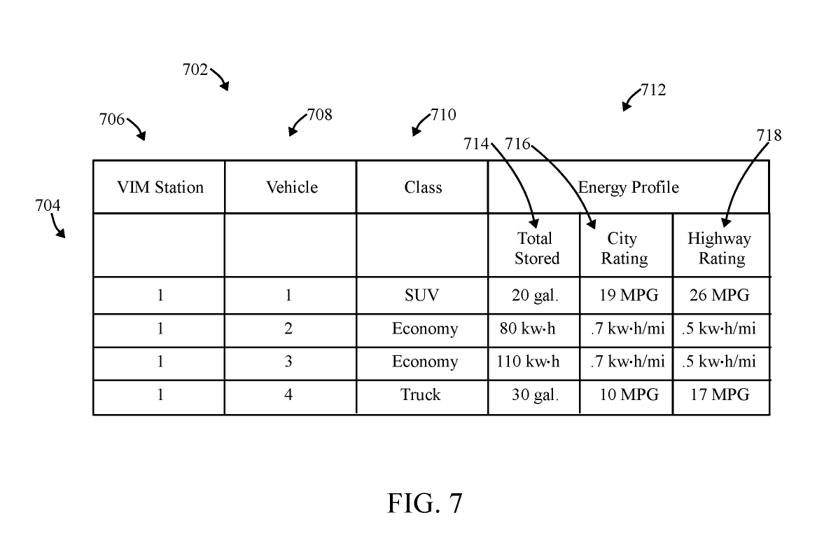

FIG. 7 illustrates a portion of a database that may be maintained by a VIM station 102 and/or the SM server 116 in accordance with embodiments herein. The database 702 includes a collection of records 704 associated with each available vehicle for a VIM station 102. The records 704 indicate the VIM station identifier 706, a vehicle identifier 708, a class of vehicle 710 and energy profiles 712. The energy profiles 712 may include various information. For example, the energy profile 712 may include the total stored energy 714 that is presently available within the vehicle. The energy profile 712 may also include first and second energy depletion ratings 716 and 718 associated with one or more of the vehicles. In the present example, the energy depletion ratings 716 and 718 correspond to city and highway ratings, although it is understood that alternative or additional ratings may be utilized. A portion of the vehicles may include a single energy depletion rate, while another portion of the vehicles may include first and second energy depletion rates, while yet another portion of the vehicles may include more than two energy depletion rates. As explained herein, for any given vehicle, one of the energy depletion rates is chosen to calculate whether the vehicle includes sufficient stored energy to satisfy a usage limit. The energy depletion rate that is chosen may be selected based at least in part on the user device usage pattern and/or more generally on the user's historic energy consumption.

Continuing with the example of FIG. 7, the vehicle 1 represents an SUV that presently has 20 gallons of fuel, has a city rating of 19 MPG and a highway rating of 26 MPG. The vehicles 2 and 3 represent electric economy cars that have total stored battery charges of 80 KWH and 110 KWH, respectively. The vehicles 2 and 3 have the same city ratings (0.7 KWH per mile) and the same highway ratings (0.5 KWH per mile). The vehicle number 4, stored at VIM station 1, represents a truck that presently has 30 gallons of fuel, a city rating of 10 MPG and highway rating of 17 MPG.

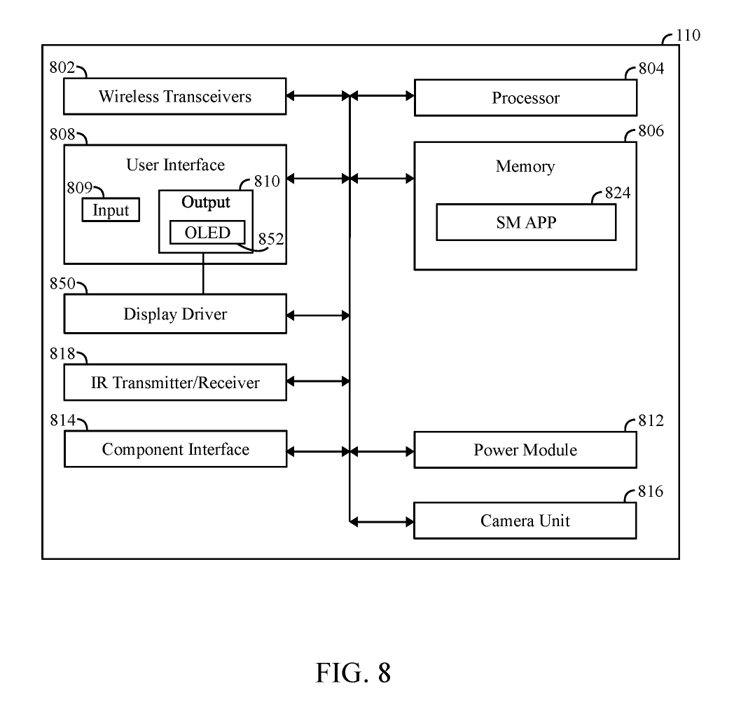

FIG. 8 illustrates a simplified block diagram of internal components of the electronic device 110 configured in accordance with embodiments herein. The device 110 includes components such as one or more wireless transceivers 802, one or more processors 804 (e.g., a microprocessor, microcomputer, application-specific integrated circuit, etc.), one or more local storage medium (also referred to as a memory) 806, a user interface 808 which includes one or more input devices 809 and one or more output devices 810, a power module 812, a component interface 814 and a camera unit 816. All of these components can be operatively coupled to one another, and can be in communication with one another, by way of one or more internal communication links, such as an internal bus. The camera unit 816 may capture one or more frames of image data.

The input and output devices 809, 810 may each include a variety of visual, audio, and/or mechanical devices. For example, the input devices 809 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 810 can include a visual output device, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 810 may include a touch sensitive screen, a non-touch sensitive screen, a text-only display, a smart phone display, an audio output (e.g., a speaker or headphone jack), and/or any combination thereof. Optionally, the input devices 809 may include one or more touch sensitive layers provided on the front and/or rear sides of the display 852.

The transceiver 802 can utilize a known wireless technology for communication. Exemplary operation of the wireless transceivers 802 in conjunction with other components of the device 110 may take a variety of forms and may include, for example, operation in which, upon reception of wireless signals, the components of device 110 detect communication signals from secondary devices and the transceiver 802 demodulates the communication signals to recover incoming information, such as responses to inquiry requests, voice and/or data, transmitted by the wireless signals. The processor 804 formats outgoing information and conveys the outgoing information to one or more of the wireless transceivers 802 for modulation to communication signals. The wireless transceiver(s) 802 convey the modulated signals to a remote device, such as a cell tower or a remote server (not shown).

The memory 806 can encompass one or more memory devices of any of a variety of forms (e.g., read only memory, random access memory, static random access memory, dynamic random access memory, etc.) and can be used by the processor 804 to store and retrieve data. The data that is stored by the memory 806 can include, but need not be limited to, operating systems, applications, user collected content and informational data. Each operating system includes executable code that controls basic functions of the device, such as interaction among the various components, communication with external devices via the wireless transceivers 802 and/or the component interface 814, and storage and retrieval of applications and data to and from the memory 806. Each application includes executable code that utilizes an operating system to provide more specific functionality for the communication devices, such as file system service and handling of protected and unprotected data stored in the memory 806.

A share management (SM) application 824 is stored in memory 806. The SM application 824 includes program instructions accessible by the one or more processors 804 to direct a processor 804 to implement the methods, processes and operations described herein including, but not limited to the methods, processes and operations illustrated in the FIGS. and described in connection with the FIGS. The SM application 824 manages operation of the processor 804, in connection with performing share request operations, entering usage planning information, managing user profile, selecting a candidate device from the list of candidate devices and the like. The SM application 824 may allow the user to designate a particular station 102, 152 for which the user wishes to pick up and/or drop off a vehicle. The SM application 824 may also allow the user to enter usage limits (e.g., total miles, total fuel, total operational time).

Other applications stored in the memory 806 include various application program interfaces (APIs), some of which provide links to/from the cloud hosting service. The power module 812 preferably includes a power supply, such as a battery, for providing power to the other components while enabling the device 110 to be portable, as well as circuitry providing for the battery to be recharged. The component interface 814 provides a direct connection to other devices, auxiliary components, or accessories for additional or enhanced functionality, and in particular, can include a USB port for linking to a user device with a USB cable.

Optionally, the device 110 may include an infrared (IR) transmitter/receiver 818 that may be utilized in connection with controlling one or more secondary devices through transmission and reception of IR signals. A display driver 850 is coupled to the processor 804 and configured to manage display of content on a display 852. Optionally, the display driver 850 may omit a separate processor and memory, and alternatively or additionally, utilize sections of the memory 806 as display memory and the processor 804 to manage writing content to a display memory section within the memory 806.

### CLOSING STATEMENTS

Before concluding, it is to be understood that although e.g., a software application for undertaking embodiments herein may be vended with a device such as the system 100, embodiments herein apply in instances where such an application is e.g., downloaded from a server to a device over a network such as the Internet. Furthermore, embodiments herein apply in instances where e.g., such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method, comprising:
under control of one or more processors programmed with specific executable instructions,
obtaining a user profile that includes a user device usage pattern associated with a user;
receiving a usage limit associated with a task; and
identifying a candidate mobile device from a pool of available mobile devices based on the usage limit and the user device usage pattern.

2. The method of claim 1, wherein the identifying includes identifying, as the candidate mobile device, one or more of the available mobile devices that has a stored energy level that satisfies the usage limit based on the user device usage pattern.

3. The method of claim 2, wherein the mobile devices represent vehicles and the task represents traveling to a destination location, the identifying further comprising identifying, as a candidate vehicle, one or more available vehicles that includes a total stored energy sufficient to reach the destination location based on the user device usage pattern and energy depletion rates of the corresponding available vehicles.

4. The method of claim 2, wherein the mobile devices represent portable handheld devices and the task represents operating the mobile device for a designated period of time, the identifying further comprising identifying, as a candidate handheld device, one or more of available handheld devices that includes a total stored energy sufficient to operate for the designated period of time based on the user device usage pattern and energy depletion rates of the corresponding available handheld devices.

5. The method of claim 1, the method further comprising calculating a route between starting and destination locations, wherein the usage limit is based on the route.

6. The method of claim 5, wherein the usage limit includes a total distance between the starting and designated destinations, the method further comprising calculating the total distance based on the route.

7. The method of claim 1, further comprising calculating the user device usage pattern based on historic energy consumption by the user and saving the user device usage pattern in the user profile.

8. The method of claim 1, wherein at least a portion the available mobile devices exhibit first and second energy depletion rates, the method further comprising selecting between the first and second energy depletion rates based on the user device usage pattern and determining whether the corresponding available mobile devices include a stored energy level sufficient to satisfy the usage limit based on the selected one of the first and second energy depletion rates.

9. The method of claim 1, further comprising receiving device usage data associated with a device sharing task, and calculating an update to the user profile based on the device usage data.

10. The method of claim 1, further comprising receiving device usage data associated with a returned mobile device, and calculating an energy depletion rate associated with the corresponding returned mobile device.

11. A system, comprising:
a processor;
a memory storing instructions accessible by the processor;
wherein, responsive to execution of the instructions, the processor to perform the following:
obtain a user profile that includes a user device usage pattern associated with a user;
receive a usage limit associated with a task; and
identify a candidate mobile device from a pool of available mobile devices based on the usage limit and the user device usage pattern.

12. The system of claim 11, the processor to identify, as the candidate mobile devices, one or more of the available mobile devices that has a stored energy level that satisfies the usage limit based on the user device usage pattern.

13. The system of claim 11, wherein the mobile devices represent vehicles, the processor to identify, as a candidate vehicle, one or more of available vehicles that includes a total stored energy sufficient to reach the destination location based on the user device usage pattern and energy depletion rates of the corresponding available vehicles.

14. The system of claim 11, wherein the mobile devices represent portable handheld devices, the processor to identify, as the candidate mobile device, one or more of available mobile devices that includes a total stored energy sufficient to operate for a total amount of time based on the user device usage pattern and energy depletion rates of the corresponding available mobile device.

15. The system of claim 11, the processor to calculate a route between starting and destination locations, wherein the usage limit is based on the route.

16. The system of claim 15, wherein the usage limit includes a total distance between the starting location and the designated destination, the processor to calculate the total distance based on the route.

17. A computer program product comprising a non-signal computer readable storage medium comprising computer executable code to:
obtain a user profile that includes a user device usage pattern associated with a user;
receive a usage limit associated with a task; and
identify a candidate mobile device from a pool of available mobile devices based on the usage limit and the user device usage pattern.

18. The computer program product of claim 17, further comprising computer executable code to calculate the user device usage pattern based on historic energy consumption by the user associated saved in the user profile.

19. The computer program product of claim 17, wherein at least a portion of the available mobile devices include first and second energy depletion rates, the computer executable code to select between the first and second energy depletion rates based on the user device usage pattern and determine whether the corresponding available mobile device include a stored energy level sufficient to satisfy the usage limit based on the selected one of the first and second energy depletion rates.

20. The computer program product of claim 17, further comprising computer executable code to receive device usage data associated with a device sharing operation, and calculate an update to the user profile based on the device usage data.
